(19) United States
(12) Patent Application Publication
(10) Pub. No.: US 2023/0404258 A1
(43) Pub. Date: Dec. 21, 2023

(54) INTERLOCKING ELEMENTS FOR CREATING STRUCTURES

(71) Applicant: M. Toby Samples, Anacortes, WA (US)

(72) Inventor: M. Toby Samples, Anacortes, WA (US)

(21) Appl. No.: 17/843,755

(22) Filed: Jun. 17, 2022

(51) Int. Cl. A47B 73/00

(52) U.S. Cl. CPC A47B 73/006

(57) ABSTRACT

A modular interconnecting element includes a first connector portion configured to interconnect with a second connector portion of a second modular interconnecting element, and an attachment portion configured to attach a structure formed by interconnecting the modular interconnecting elements to a surface. The first connector portion may be a universal connector portion and may take the form of a hook. The attachment portion may be a mounting feature such as a circular boss that is configured to receive a fastener. The first connector portion may be attached to the attachment portion by an arm.

### FIELD OF THE DESCRIPTION

This disclosure relates to modular interlocking elements for creating structures. The modular elements are attachable to each other and interlock together to create simple or complex structures.

### BACKGROUND

Products of many kinds have varying structural characteristics and perform various functions. To achieve these structural characteristics and functions, the ability to form simple and complex shapes is needed which has led to techniques such as molding, extrusion, three-dimensional (3D) printing, etc. to form products into desired structural shapes. Such techniques are limited in the size of products that can be produced and the structural characteristics that can be provided. The ability to change the shape of or disassemble the product once formed is typically extremely limited or non-existent.

There is a need for the ability to form a structure of any desired shape and configuration quickly and easily while also having the ability to change the shape of the structure or to disassemble/reassemble the structure quickly and easily. In addition, for some types of structures such as shelving units, for example, there is a need for a mechanism to permit attachment of the formed structure to a surface such as a wall.

### SUMMARY

This disclosure provides modular interlocking elements for creating structures quickly and easily. Each modular interlocking element includes a connector portion for connecting to another interlocking element, and an attachment portion for attaching a structure formed by the interlocking elements to a surface such as a wall or to a skin for covering the structure formed by the interlocking elements. In one implementation, the connector portion is a hook, and the attachment portion is a circular boss. In one example, the attachment portion is formed by interlocked connector portions.

One aspect of this disclosure is directed to a modular interconnecting element. The modular interconnecting element comprises a first connector portion configured to interconnect with a second connector portion of a second modular interconnecting element, and an attachment portion configured to attach a structure formed by interconnecting the modular interconnecting elements to a surface. In various implementations, the first connector portion is a universal or asexual connector portion and may take the form of a hook. The attachment portion may be a mounting feature such as a circular boss that is configured to receive a fastener. The first connector portion may be attached to the attachment portion by an arm.

Another aspect of this disclosure is directed to a modular interconnecting element comprising a first connector/attachment portion configured to interconnect with a second connector/attachment portion of a second modular interconnecting element. The interconnection of the first and second connector/attachment portions forms a boss for attachment of a structure formed by the first and the second modular interconnecting elements to a surface.

A further aspect of this disclosure is directed to a method for forming a modular interconnecting element. The method comprises forming the modular interconnecting element with a connector portion configured to interlock with a connector portion of an adjacent modular interconnecting element and forming the modular interconnecting element with an attachment portion configured to attach a structure formed by multiple modular interlocking elements to a surface. In one non-limiting example, the modular interconnecting element is formed by extrusion.

These and other aspects of this disclosure are described in the following description and depicted in the drawing figures.

### BRIEF DESCRIPTION OF THE DRAWINGS

Various features and advantages of this disclosure are depicted in the drawing figures. The drawings are not necessarily to scale; emphasis instead is placed on illustrating the principles of the disclosure. In the drawings, like reference characters may refer to the same parts throughout. The drawings depict only illustrative examples of this disclosure and are not limiting in scope.

FIG. 1A is a top view of one embodiment of an interconnecting element, in accordance with this disclosure.

FIG. 1B is a top view of a structure formed by interconnecting multiple instances of the interconnecting element of FIG. 1A, in accordance with this disclosure.

FIG. 2A is a top view of another embodiment of an interconnecting element, in accordance with this disclosure.

FIG. 2B is a top view of a structure formed by interconnecting multiple instances of the interconnecting element of FIG. 2A, in accordance with this disclosure.

FIG. 2C is a perspective view showing the structure of FIG. 2B being attached to a surface, in accordance with this disclosure.

FIG. 3A is a perspective view of another embodiment of an interconnecting element, in accordance with this disclosure.

FIG. 3B is a perspective view showing a structure formed by interconnecting multiple instances of the interconnecting element of FIG. 3A being attached to a surface, in accordance with this disclosure.

FIG. 3C is a perspective view showing the structure of FIG. 3B attached to the surface of FIG. 3B to form a modular shelving unit, in accordance with this disclosure.

FIG. 3D is a top view of the modular shelving unit of FIG. 3D, in accordance with this disclosure.

FIG. 3E is a perspective view showing the modular shelving unit of FIG. 3D holding bottles, in accordance with this disclosure.

FIG. 4A is a perspective view of another embodiment of an interconnecting element, in accordance with this disclosure.

FIG. 4B is a perspective view of another embodiment of an interconnecting element, in accordance with this disclosure.

FIG. 4C is a perspective view of a spherical structure formed by interconnecting multiple instances of the interconnecting elements of FIGS. 4A and 4B, in accordance with this disclosure.

FIG. 4D is another perspective view showing attachment of the upper skin to the upper portion of the spherical structure of FIG. 4C, in accordance with this disclosure.

FIG. 4E is a perspective view showing upper and lower skins attached to the upper and lower portions of the spherical structure of FIG. 4C to form an enclosed sphere or hollow ball, in accordance with this disclosure.

FIG. 5A is a perspective view of another embodiment of an interconnecting element, in accordance with this disclosure.

FIG. 5B is a perspective view of a structure formed using the interconnecting element of FIG. 5A, in accordance with this disclosure.

FIG. 5C is a perspective view of additional embodiments of interconnecting elements and a structure formed by interconnecting such elements, in accordance with this disclosure.

FIG. 6. is a perspective view showing “out-of-plane” embodiments of interconnecting elements, in accordance with this disclosure.

### DETAILED DESCRIPTION

A plurality of modular interconnecting elements formed from lightweight materials is described herein. The interconnecting elements are connected to create structures, with flexibility in the shape, design, performance, and structural characteristics of such structures. The modular interconnecting elements provide the ability to customize the formation of a structure for a wide variety of applications. In one non-limiting example, the modular interconnecting elements are connected to form a shelving unit. In another non-limiting example, the modular interconnecting elements are connected to form a hollow, spherical structure such as a basketball. In a further non-limiting example, the interconnecting elements may be used as toys to form structures such as toys.

The structures formed by interconnection of the modular elements may have outstanding out-of-plane compressive strength for handling stress and loading. Tensile, shear, bending and flexural strength may be tuned as needed, and the structures formed by interconnecting the elements may have a high strength to weight ratio. The configurations of the modular interconnecting elements allow construction of virtually unlimited configurations of structures, as well as the ability to change or tune the shape and other characteristics of the structures such as weight, configuration, size, strength, etc. The structure formed by the interlocking elements can be self-supporting or can serve as a reinforcing layer between solid, laminate or other boundary layers in a composite-type product.

The interlocking elements used to create a structure can be uniform and identical or can have different and varying shapes and features. The use of modular interlocking elements allows for easy repair of a structure formed from the elements in the event of damage to one or more of the elements. Further, the ability to customize the modular interlocking elements for a particular application allows for on demand manufacture and shipment of the elements and/or manufacture of the elements on sight for assembly.

The modular interlocking elements may be made of any suitable material, including for example, polymeric materials, ceramic materials, epoxy resin, fibrous materials, moldable materials, thermoplastic or thermoset materials, other non-metallic materials, laminated materials and the like, steel, aluminum or other metals, composites, carbon fiber, and any such materials in combination. Methods of manufacturing the modular interlocking elements disclosed herein include, without limitation, extrusion, additive manufacturing, or 3D printing, milling, molding, machining manufacturing methods (including CNC machining, laser cutting, waterjet cutting, turning, and the like), or any other suitable method or combination of methods. Software may be used in conjunction with the method of manufacturing to design, implement and control the manufacturing process. Where a plurality of identical modular elements is being manufactured, for example, extrusion techniques may be an appropriate and cost-effective method of manufacture. Where a wide variety of interlocking modular elements are needed with varying shapes and/or varying characteristics such as thicknesses, additive manufacturing (3D printing) may be an appropriate and cost-effective method of manufacture.

The modular interconnecting elements are configured with universal or asexual connector portions that engage and interlock with the universal or asexual connector portions of adjacent interconnecting elements. The connector portion may be a circular or semi-circular shape, in the form of a hook for example, that interconnects with a similarly shaped connector portion of another element. Each modular interconnecting element may have one or more universal connector portions for interconnection with universal connector portions of other modular elements. The terms “universal” and “asexual” refer to a connector portion that can both engage and receive, in contrast to male engaging features (which only engage) and female receiving features (which only receive). Use of a universal connector portion increases flexibility for combining multiple interconnecting elements into a desired structure and eliminates the need for mating male and female connector portions. In one non-limiting example, the universal connector portion comprises a hook that is seated within and has a suitable fit with a hook of an adjacent interconnecting element. A loose fit may also be employed, for example, where it is desired to flow resin through the joint. In the following description, the term “suitable fit” refers to any fit between interconnecting elements that is suitable for the structure at issue, and includes without limitation close, interference, friction, loose and any other suitable types of fit.

The modular interconnecting elements are further configured with attachment portions that provide for attachment of the structure formed by the elements to a surface such as a wall or a skin. In one non-limiting example, the attachment portion is a mounting feature that will receive a screw, thread-forming screw, or any other suitable fastener, such as a circular or other suitably shaped boss. In one non-limiting example, the attachment portion is a circular boss that is connected by arms to one or more connector portions. In another non-limiting example, the connector portions are configured in such a manner that when interconnected, the interconnected connector portions define an attachment portion, such as a boss. In the following description, the term “boss” means any attachment portion or mounting feature suitable to receive a fastener.

These and other details of the modular interconnecting elements are described below in conjunction with the drawing figures.

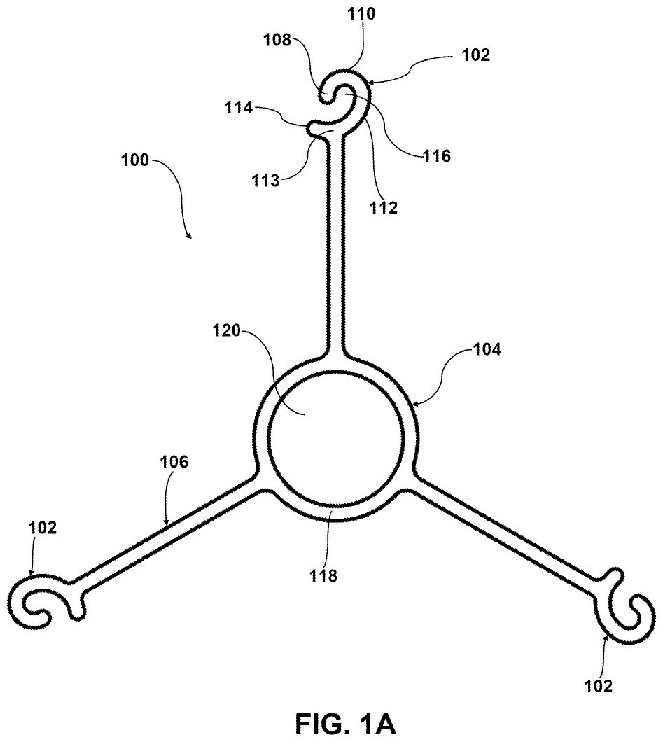

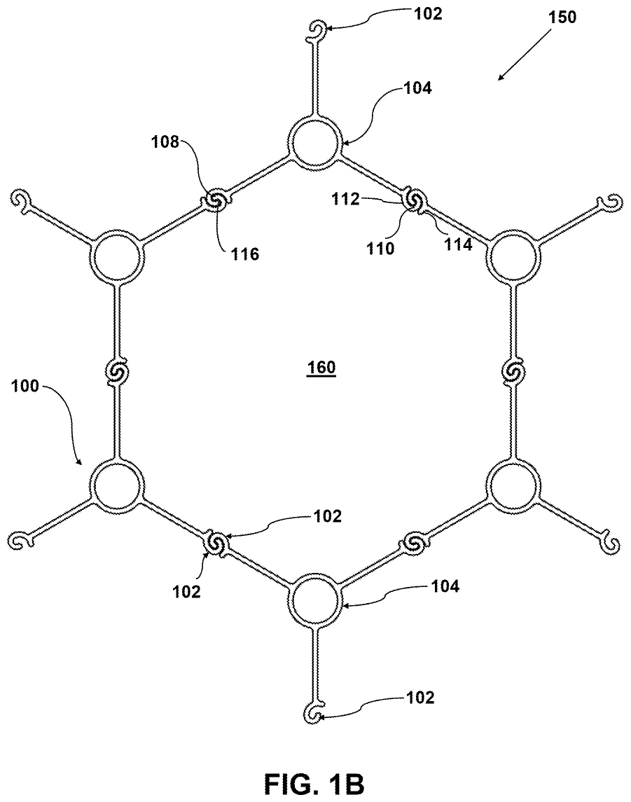

FIG. 1A is a top view of one embodiment of an interconnecting element 100, in accordance with this disclosure. In one implementation, interconnecting element 100 is a tri-hook center boss interconnecting element comprising three connector portions 102 connected to a central attachment portion 104 by three arms 106. In a non-limiting example, connector portions 102 are formed to be universal or asexual connectors and are configured to interconnect with a similarly sized and shaped connector portion of another interconnecting element.

As can be seen in FIG. 1A, in one non-limiting example, each connector portion 102 approximately resembles a “yin-yang” symbol and takes the form of a hook that extends from a tip 108, through an approximately 180-degree bend 110, a shank 112 that is straight or approximately straight for an initial length and that then gently curves to an intersection 113 with arm 106. A nub 114 is formed at an opposite side of junction 113. Nub 114 is at approximately a angle with arm 106 and assists in securing the fit with another connector portion 102. Together, tip 108, bend 110, shank 112 and nub 114 define a receptacle 116 that receives and forms a suitable fit with another connector portion 102.

Attachment portion 104 is formed at the interior ends of arms 106 opposite from connector portions 102 and takes the form of a boss having a circular perimeter 118 defining a central void 120. In a non-limiting embodiment, void 120 is a capable of receiving a fastener such as a screw or the like to mount an interconnected structure formed by interconnecting elements 100 to a surface such as a wall.

While connector portions 102 and attachment portion 104 have been described respectively as a hook and a circular boss, it should be noted that connector portions 102 and attachment portion 104 may take any other suitable shapes and forms. For example, connector portion 102 could have straight rather than curved surfaces, and attachment portion 104 could have a square, hexagonal or other shape to receive like-shaped fasteners. Importantly, connector portion 102 should have a universal or asexual shape that permits interconnection with like-shaped connector portions, and attachment portion 104 should have a shape that permits reception of a complementary fastener. The complexity of connector portion 102 could be increased to add strength and stability. One or more hook features could interlock in a non-circular manner. Connector portion 102 illustrated in FIG. 1A allows an interconnected circular hook to rotate within the coupling. A non-circular feature may be added if desired to connector portion 102 to eliminate such rotation. Connector portion 102 may have, for example, an extended appendage of straight/non-circular walls in its profile.

FIG. 1B is a top view of a structure 150 formed by interconnecting multiple instances of interconnecting element 100 of FIG. 1A, in accordance with this disclosure. As can be seen in FIG. 1A, connector portions 102 of adjacent interconnecting elements 100 are interconnected in a suitable fit to form structure 150. Tip 108 of one connector portion is received within receptacle 116 of an adjacent connector portion 102. In addition, bend 110 of one connector is partially overlaid by nub 114 of an adjacent connector to secure the fit between the two connector portions. In this regard, nub 114 may be lengthened if needed, following the curve of bend 110 and shank 112, to increase the security of the fit.

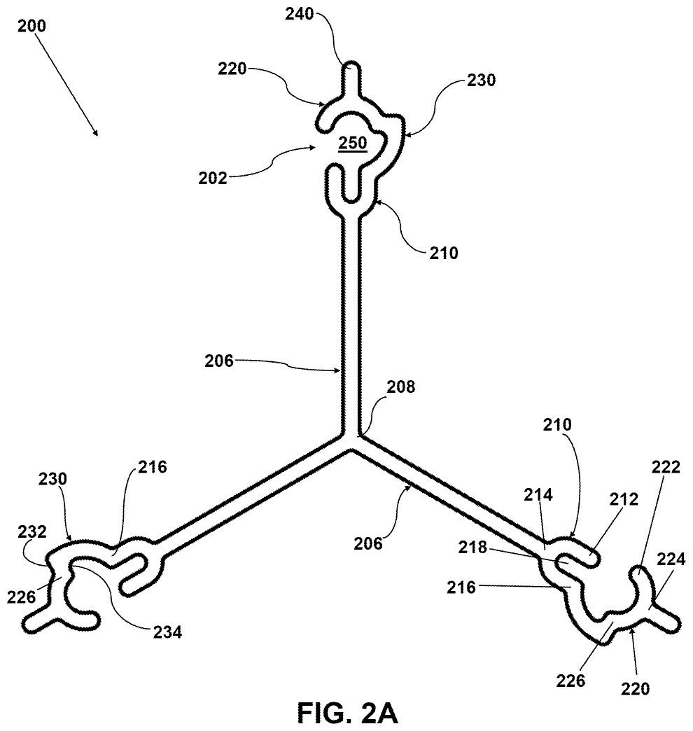

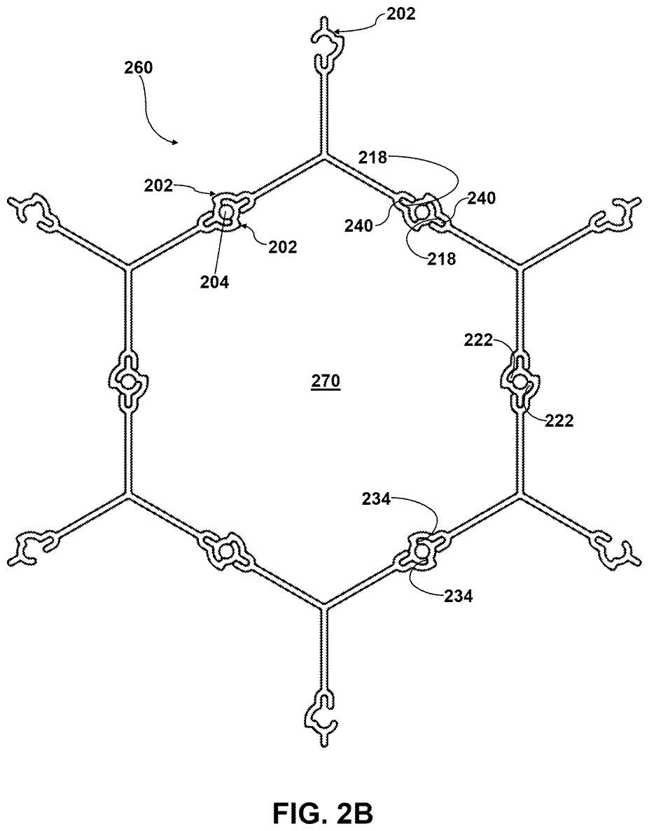

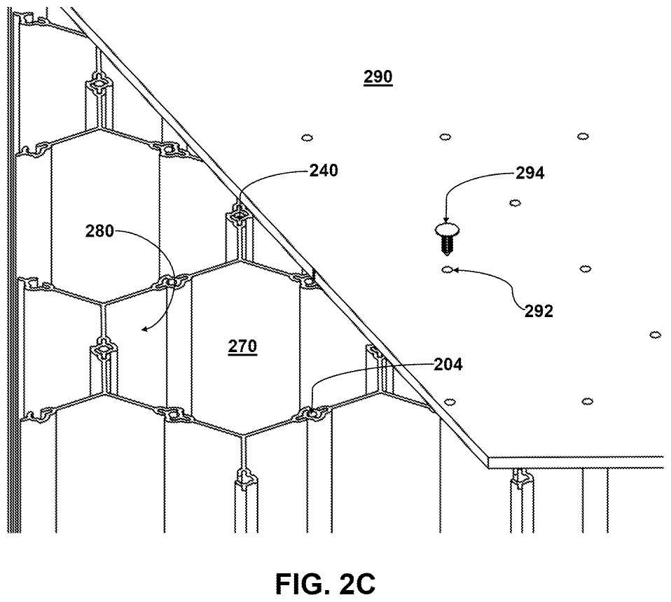

In the non-limiting example of FIG. 1B, six interconnecting elements 100 are interconnected to form hexagonally shaped structure 150. Structure 150 includes six attachment portions 104, in the form of circular bosses, for attaching structure 150 to a surface, such as a wall for example. Each interconnecting element 100 has two of its connector portions 102 interconnected in a suitable fit with connector portions 102 of adjacent interconnecting elements, and a free connector portion 102 for possible attachment to other interconnecting portions or structures. Structure 150 formed by interconnecting elements 100 defines a central void 160. Multiple instances of structure 150 may be interconnected to form a larger structure such as, for example, a modular shelving unit wherein voids 150 define spaces for reception of objects to be shelved, and the modular shelving unit is attached to a wall or other surface by use of attachment portions 104, as shown for example in FIGS. 2C-2D.

While FIG. 1B is presented to illustrate one non-limiting example of a structure 150 that can be formed by interconnection of interconnecting elements 100, this is just one example, and that virtually limitless other shapes, forms, and structures may be formed by interconnection of interconnecting elements 100 to suit whatever purpose or function is desired.

FIG. 2A is a top view of another embodiment of an interconnecting element 200, in accordance with this disclosure. In one implementation, interconnecting element 200 is a tri-hook-boss interconnecting element comprising three connector/attachment portions 202 formed at ends of arms 206. The opposite ends of arms 206 connect at a central portion 208 of interconnecting element 200. As can be seen in FIG. 2A, each connector/attachment portion 202 includes a U-shaped portion 210 connected to an end of an arm 206; a bowl-shaped portion 220 formed opposite to and facing U-shaped portion 210; a cup-shaped portion 230 joining U-shaped portion 210 and bowl-shaped portion 220; and a reinforcement member 240 co-linear with arm 206 and extending away from the top of bowl-shaped portion 220. Together, U-shaped portion 210, bowl-shaped portion 220, and cup-shaped portion 230 form a receptacle 250 for receiving and forming a suitable fit with another connector/attachment portion 202.

U-shaped portion 210 extends from a free end 212, through a junction 214 with arm 206, to a junction 216 with cup-shaped portion 230. U-shaped portion 210 further defines an internal slot 218 configured to receive a reinforcement member 240 of another interconnecting element 200. Bowl-shaped portion 220 extends from a free end 222, through a junction 224 with reinforcement member 240, to a junction 226 with cup-shaped member 230. Cup-shaped portion 230 extends between junction 216 with U-shaped portion 210 and junction 226 with bowl-shaped portion 220 and defines external shoulder 232 and internal shoulder 234.

FIG. 2B is a top view of a structure 260 formed by interconnecting multiple instances of the interconnecting element 200 of FIG. 2A, in accordance with this disclosure. As can be seen in FIG. 2B, attachment/connector portions 202 interconnect with a suitable fit to not only form an interconnected structure 260, but also to form bosses 204 within their interconnection, such that attachment and connector portions 202 are referred to as “hook-bosses”. In particular, the reinforcement member 240 of a first connector/attachment portion 202 is received within slot 218 of a second connector/attachment portion 202, while free end 222 of the bowl-shaped portion 220 of the first connector/attachment portion 202 abuts internal shoulder 234 of cup-shaped portion 230 of the second connector/attachment portion 202. Likewise, the reinforcement member 240 of the second connector/attachment portion 202 is received within slot 218 of the first connector/attachment portion 202, and free end 222 of the bowl-shaped portion 220 of the second connector attachment portion 202 abuts internal shoulder 234 of cup-shaped portion 230 of the first connector attachment/portion 202. The result is a suitable fit between the two connector/attachment portions 202, as well as a circular “hook boss” 204 formed by the adjacent bowl-shaped portions 220 of the adjacent connector/attachment portions 202.

In the non-limiting example of FIG. 2B, six interconnecting elements 200 are interconnected to form hexagonally shaped structure 260. Structure 260 includes six “hook bosses” 204 for attaching structure 260 to a surface, such as a wall for example. Each interconnecting element 200 has two of its connector/attachment portions 202 interconnected in a suitable fit with connector/attachment portions 202 of adjacent interconnecting elements, and a free connector/attachment portion 202 for possible attachment to other interconnecting portions or structures. Structure 260 formed by interconnecting elements 200 defines a central void 270. While FIG. 2B is presented to illustrate one non-limiting example of a structure 260 that can be formed by interconnection of interconnecting elements 200, this is just one example, and virtually limitless other shapes, forms and structures may be formed by interconnection of interconnecting elements 200 to suit whatever purpose or function is desired.

As shown in FIG. 2C, multiple instances of structure 260 may be interconnected to form a larger structure such as a modular shelving unit 280. wherein voids 270 define spaces for reception of objects to be shelved, and modular shelving unit 280 is attached to a wall or other surface 290. FIG. 2C is a perspective view showing interconnected structures 260 forming a modular shelving unit 280 that is attached to surface 290. Bosses 292 formed through surface 290 are aligned with hook bosses 204 of modular shelving unit 280 (formed by interconnected structures 260), and fasteners 294 (such as screws, in one non-limiting example) are then placed through the aligned bosses 204 and 292 to fasten modular shelving unit 280 to a wall or another surface 290.

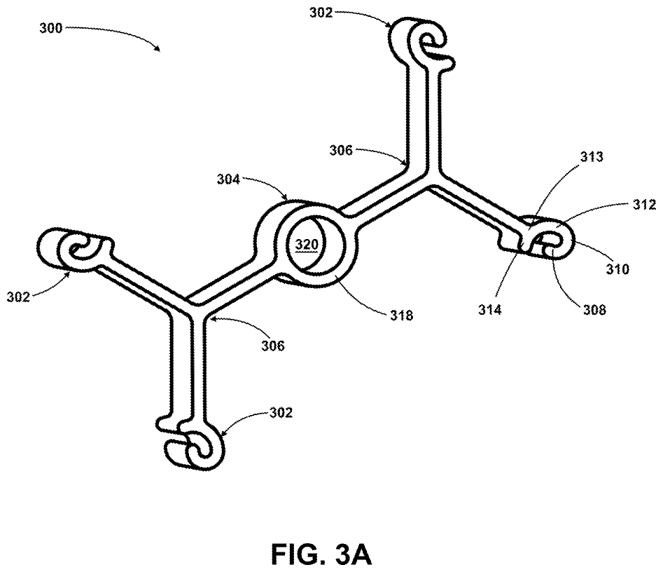

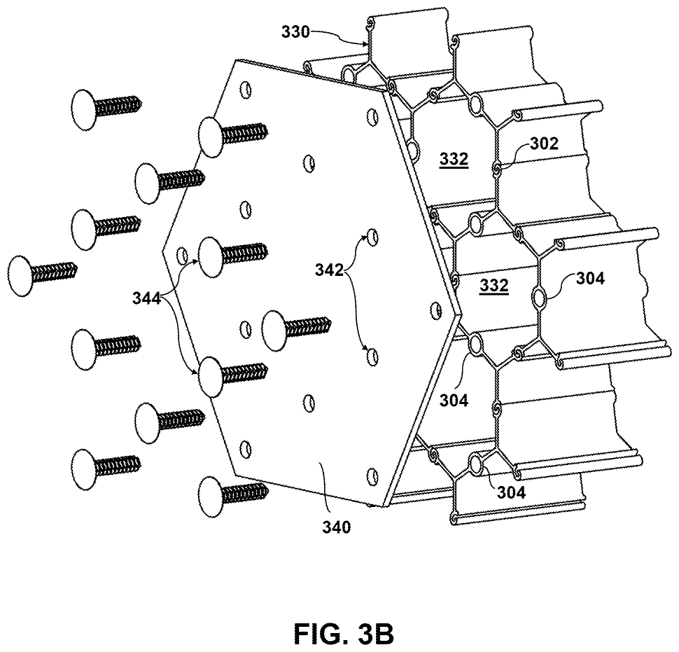

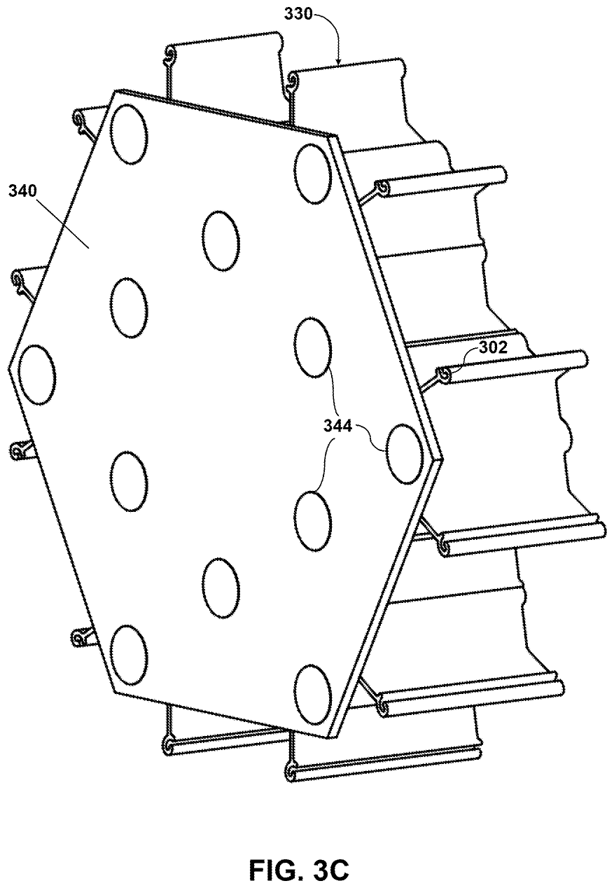

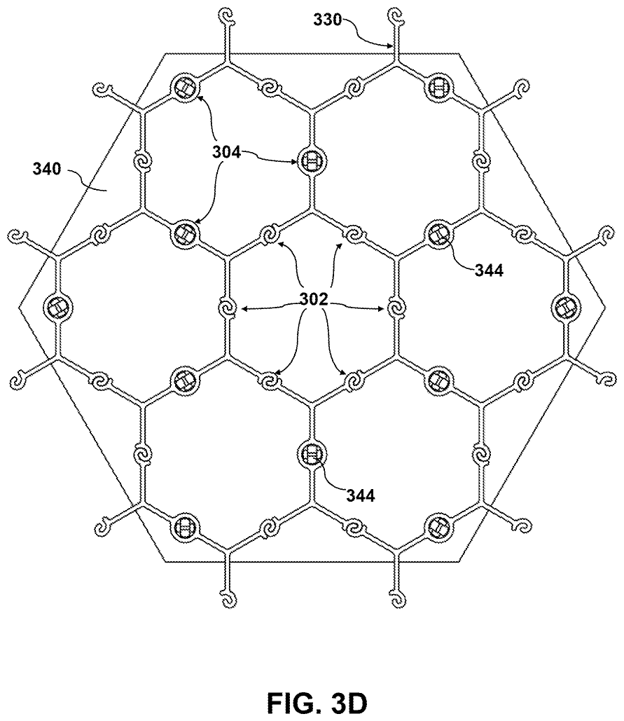

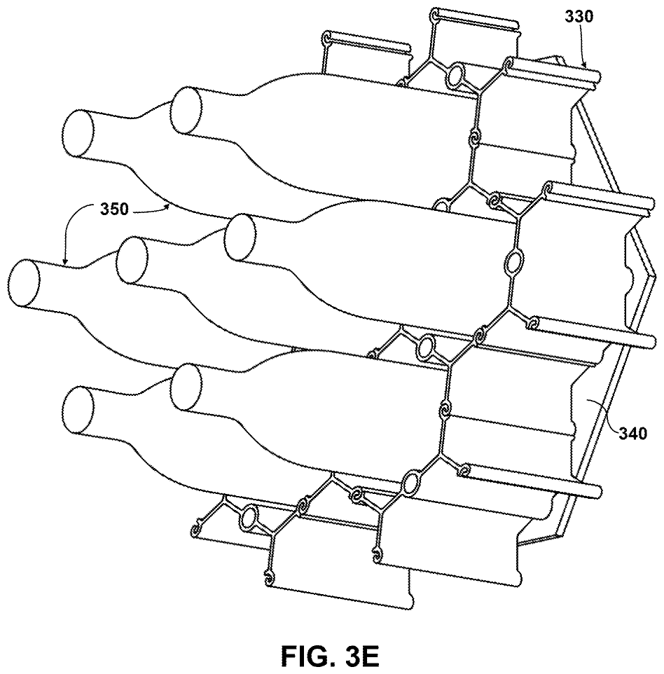

FIG. 3A is a perspective view of another embodiment of an interconnecting element 300, in accordance with this disclosure. In one implementation, interconnecting element 300 is a quad-hook center boss interconnecting element comprising four connector portions 302 connected to a central attachment portion 304 by two Y-shaped arms 306. Connector portions 302 are formed to be a universal or asexual connector and are configured to interconnect with a similarly sized and shaped connector portion of another interconnecting element.

Connector portions 302 are shaped similarly to connector portions 102 of interconnecting elements 100 (FIGS. 1A-1B). Each connector portion 302 approximately resembles a “yin-yang” symbol and takes the form of a hook that extends from a tip 308, through an approximately 180-degree bend 310, a shank 312 that is straight or approximately straight for an initial length and that then gently curves to an intersection 313 with arm 306. A nub 314 is formed at an opposite side of junction 313. Nub 314 assists in securing the fit with another connector portion 302. Together, tip 308, bend 310, shank 312 and nub 314 define a receptacle 316 that receives and forms a suitable fit with another connector portion 302. Attachment portion 304 is formed between arms 306 and takes the form of a boss having a circular perimeter 318 defining a central void 320. Void 320 receives a fastener such as a screw to mount an interconnected structure formed by interconnecting elements 300 to a surface such as a wall.

While connector portions 302 and attachment portion 304 have been described respectively as a hook and a circular boss, as with interconnecting elements 100, connector portions 302 and attachment portion 304 may take other shapes and forms. For example, connector portion 302 could have straight rather than curved surfaces, and attachment portion 304 could have a square, hexagonal or other shape to receive like-shaped fasteners. Importantly, connector portion 302 should have a universal or asexual shape that permits interconnection with like-shaped connector portions, and attachment portion 304 should have a shape that permits reception of a complementary fastener.

As shown in FIGS. 3B-3E, multiple instances of interconnecting elements 300 may be interconnected to form a larger structure 330. In a similar fashion to FIG. 2C, structure 330 may take the form of a modular shelving unit formed by interconnecting elements 300 arranged to form multiple, interconnected hexagons, wherein the voids 332 between the hexagons define spaces for shelving items. Due to the difference in shape and configuration of interconnecting elements 300, as can be seen in FIG. 3B, each hexagonal unit of structure 330 has three attachment portions (or bosses) 304 rather than six attachment portions. As shown in FIGS. 3B and 3C, modular shelving unit 330 may be attached to a wall or other surface 340. Bosses 342 formed through surface 340 are aligned with bosses 304 of modular shelving unit 330 (formed by interconnecting elements 300), and fasteners 344 (such as screws, in one non-limiting example) are then fastened through the aligned bosses 304 and 342 to fasten modular shelving unit 330 to surface 340.

FIGS. 3C and 3D show structure (modular shelving unit) 330 as completely fixed to surface 340 via fasteners 344 extending through bosses 342 of surface 340 and bosses 304 of structure 330. As can be seen in FIG. 3D, some of the hexagonal structures, such as the central hexagonal structure of the shelving unit, may be formed by the interconnections of elements 300 with no bosses at all and only connector portions 302. FIG. 3D also shows the ends of fasteners 344 within bosses 304. FIG. 3E shows items such as bottles 350 held by modular shelving unit 330. Modular shelving unit 330 via its connection to surface or wall 340 may be positioned in an angled orientation, as shown in FIG. 3E. Modular shelving unit 330 may alternatively be positioned via its connection to surface or wall 340 in a vertical orientation or in any other orientation that is desired. The front and rear faces of modular shelving unit 330 need not be parallel to one another, thereby facilitating desirable shelving features such as slopes and tapers to assist in retaining shelved objects.

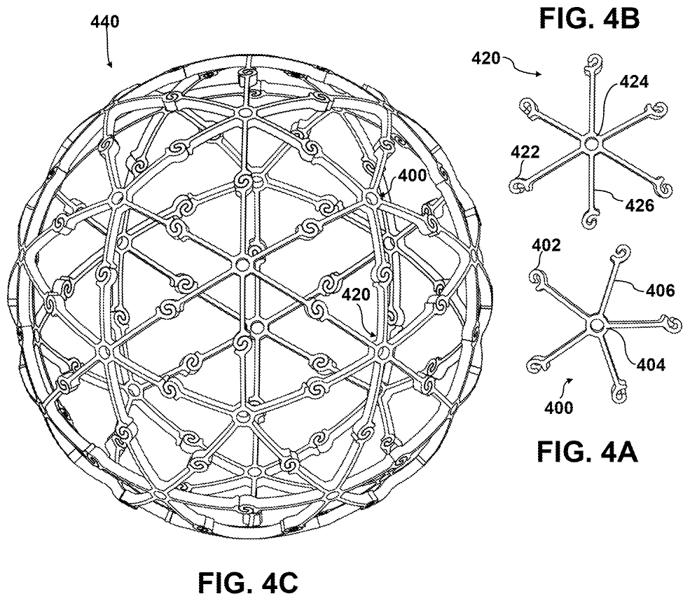

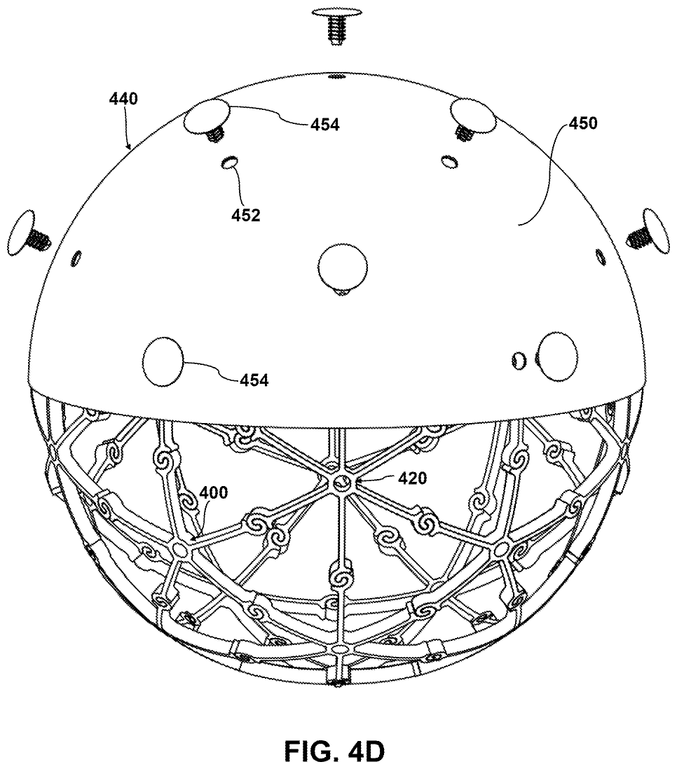

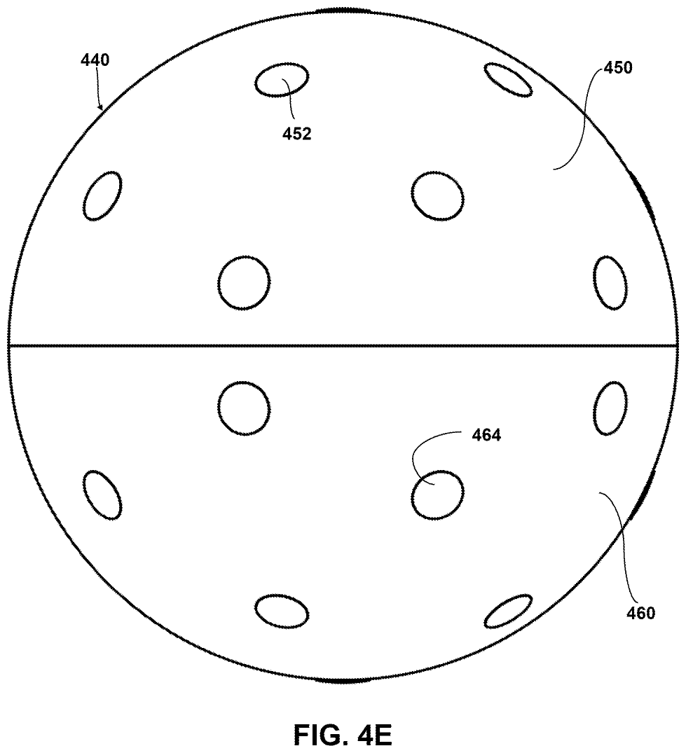

Interconnecting elements of various geometries can interconnect to create a repeating patterned structure. The components need not have a flat or planar shape but can be designed and fabricated to conform to any arbitrarily complex curved surface design, for example. This concept is illustrated in FIGS. 4A-4E. FIGS. 4A and 4B are perspective views of further embodiments of an interconnecting element 400 and an interconnecting element 420. In one implementation, interconnecting element 400 is a five-hook center boss interconnecting element comprising five connector portions 402 connected to a central attachment portion 404 by five arms 406, and interconnecting element 420 is a six-hook center boss interconnecting element comprising six connector portions 422 connected to a central attachment portion 424 by six arms 426.

Connector portions 402 and 422 of interconnecting elements 400 and 420 are shaped similarly to the connector portions of previously described interconnecting elements 100 and 300. That is, connector portions 402 and 422 have an approximate hook shape that receives and forms a suitable fit with a connector portion of another interconnecting element. Likewise, attachment portions 404 and 424 take the form of a circular boss defining a central void that receives a suitable fastener such as a screw. As described with respect to the previous interconnecting elements, the connector and attachment portions of interconnecting elements 400 and 402 may take any other suitable shapes and forms.

FIG. 4C is a perspective view of a spherical structure 440 formed by interconnecting multiple instances of interconnecting elements 400 and 420 of FIGS. 4A and 4B. To facilitate being shaped in a spherical form, interconnecting elements 400 and 420 are formed from a non-rigid material having some degree of flexibility such as a polymeric material. As shown in FIGS. 4D-4E, surfaces or “skins” may be attached to spherical structure 440 via attachment portions 404 and 424 to form an enclosed sphere or hollow ball. In one non-limiting example, an upper skin 450 is placed around the upper portion of spherical structure 440. Skin 450, as shown in FIG. 4D, has bosses or apertures 452 that are configured to be aligned with attachment portions or bosses 404 and 424 of spherical structure 440. Fasteners 454 are then fastened through the aligned bosses 454, 404 and 424 such as by threading, for example, to attach upper skin 450 to the upper portion of spherical structure 440. Likewise, as shown in FIG. 4E, a lower skin 460 is attached to the lower portion of spherical structure 440 via fasteners 464. The result is a structure having a form of an enclosed sphere or hollow ball. This is merely one of limitless examples of the structures that may be formed by use of interconnecting elements 400 and 420.

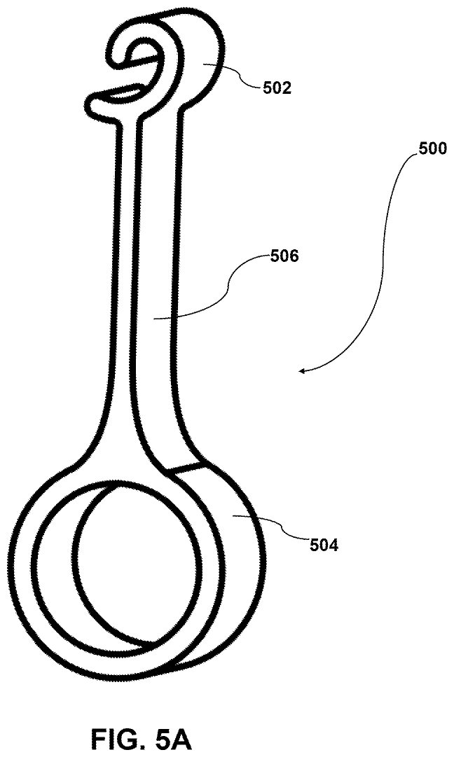

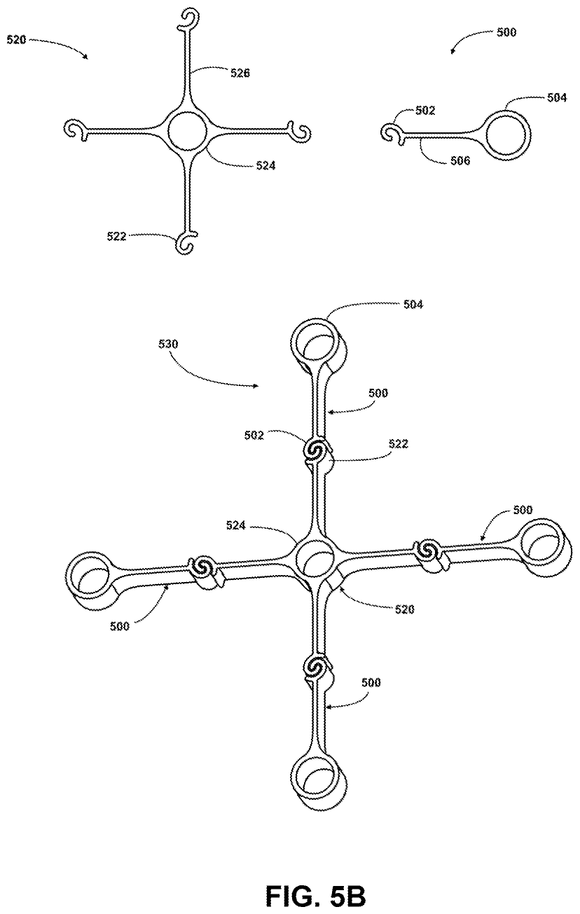

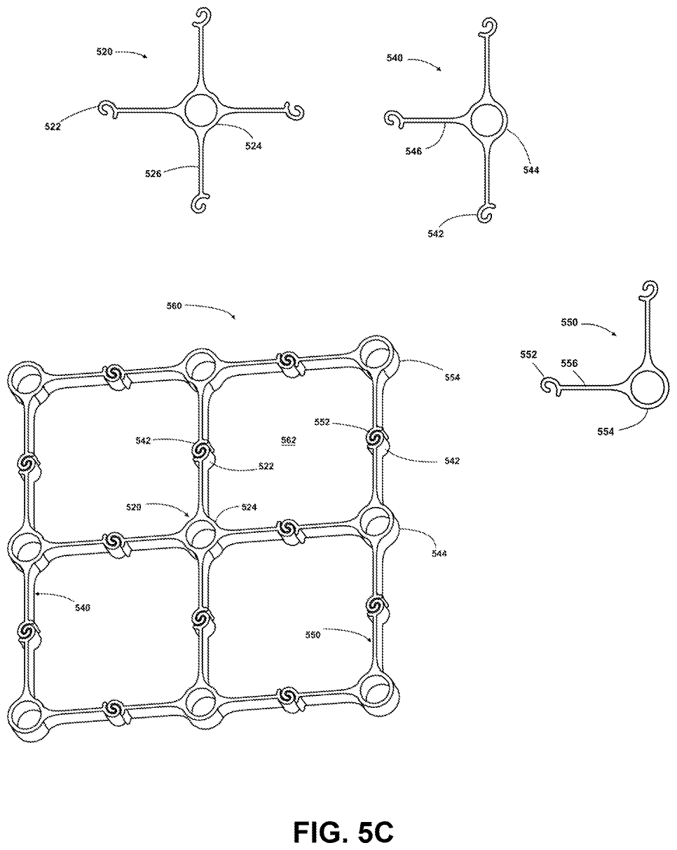

FIG. 5A is a perspective view of another embodiment of an interconnecting element 500, in accordance with this disclosure. In one implementation, interconnecting element 500 is a one-hook center boss interconnecting element comprising a connector portion 502 connected to an attachment portion 504 by an arm 506. Like previously described interconnecting elements, connector portion 502 has an approximate hook shape that receives and forms a suitable fit with a connector portion of another interconnecting element. Likewise, attachment portion 504 takes the form of a circular boss defining a central void that receives a suitable fastener such as a screw. Connector portion 502 and attachment portion 504 may take any other suitable shapes and forms.

Interconnecting element 500 is characterized in that it has been distilled down to a single connector portion (hook) and a single attachment portion (boss). Interconnecting element 500 may serve as a termination or border piece to attach to unattached connector portions of structures such as those described herein and provide an additional point of attachment to a wall or other surface. FIG. 5B, for example, shows another embodiment of an interconnecting element 520 comprising four connector portions 522 connected by four arms 526 to a central attachment portion 524, wherein the arms 526 are at ninety-degree angles to each other. The interconnecting element 500 of FIG. 5A is attached to each free connector portion 522 of interconnecting element 520 to form a structure 530 with no free hooks, a central boss 524 and four outer bosses 504, thereby facilitating attachment of structure 530 to a wall or other surface.

FIG. 5C illustrates further implementations of interconnecting elements that assist in forming “smooth” outer surfaces in structures. Structure 560 comprises interconnecting element 520 (four hooks 522, one boss 524) at its center as well as four “side” interconnecting elements 540 and four “corner” interconnecting elements 550. Side interconnecting element 540 comprises three connector portions (hooks) 542 connected by three arms 546 to an attachment portion (boss) 544. Two arms 546 are vertically aligned (180 degrees apart) while the third arm 546 is horizontally aligned and at a right angle to each of the two vertically aligned arms. Corner interconnecting element 550 comprises two connector portions (hooks) 552 connected by two arms 556 to an attachment portion (boss) 554. Arms 556 are at right angles to each other to have a corner configuration.

As can be seen in FIG. 5C, by connecting a side interconnecting element 540 to each free hook 522 of interconnecting element 520, and by connecting a corner interconnecting element 550 to the remaining free hooks 542 of side interconnecting elements 540, square structure 560 having a smooth edge pattern is formed having four square voids or spaces 562. Structure 560 may be used, for example, as a small shelving unit.

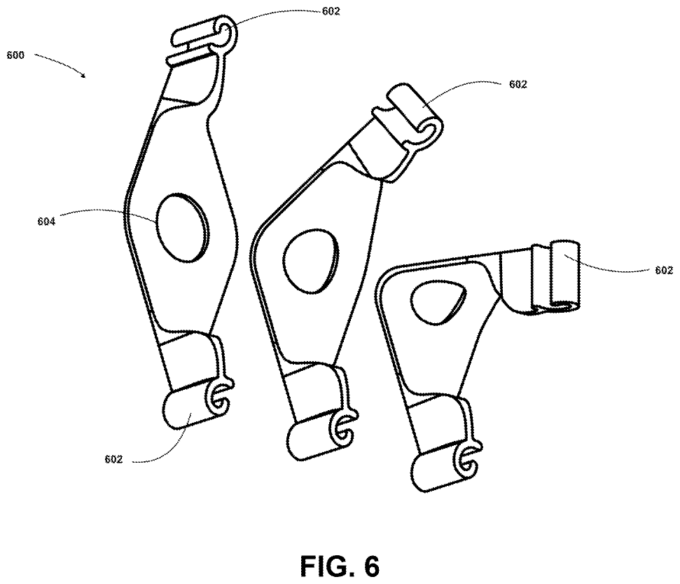

Another aspect of this disclosure is that the connector portions of an interconnecting element may be formed to be flexible and may not be aligned in the same plane. This is illustrated by interconnecting element 600 of FIG. 6. Interconnecting element has a two hook 602 and center boss 604 configuration, in which hooks 602 may be aligned in the same plane. As can be seen in FIG. 6, interconnecting element 600 may be bent or formed such that hooks 602 are forty-five degrees out of planar alignment, ninety degrees out of planar alignment, or are positioned relative to each other at whatever angle is desired. This further multiplies and expands the variety and form of structures that are possible using the interconnecting elements of the present invention.

The terms “comprising”, “including” and “having”, as used in this specification and in the following claims, indicate an open group that may include elements in addition to those elements that are specified. The terms “a”, “an”, and the singular form of words includes the plural form of such words. The terms “at least one” and “one or more” are used interchangeably. The term “single” indicates that just one of something is intended. Other specific values such as “two” indicate that a specific number of things is intended. The terms “preferably”, “preferred”, “prefer”, “optionally”, “may” and similar terms are used to indicate that an item, condition, or step being referred to is an optional (i.e., not required) feature.

While certain examples and embodiments have been described herein, such description is by way of illustration only and does not limit the scope of the following claims. Various changes, substitutions and omissions may be made without departing from the scope and content of the invention, which is defined only by the following claims. The features of any embodiment or example discussed herein may be combined with one or more features of one or more other embodiments discussed or contemplated herein unless otherwise stated.

What is claimed is:

1. A modular interconnecting element comprising:
a first connector portion configured to interconnect with a second connector portion of a second modular interconnecting element; and
an attachment portion configured to attach a structure formed by interconnecting the modular interconnecting element and the second modular interconnecting element to a surface.

2. The modular interconnecting element of claim 1, wherein the first connector portion is a universal or asexual connector portion.

3. The modular interconnecting element of claim 2, wherein the first connector portion is a hook.

4. The modular interconnecting element of claim 1, wherein the attachment portion is a mounting feature that is configured to receive a fastener.

5. The modular interconnecting element of claim 4, wherein the attachment portion is a circular boss.

6. The modular interconnecting element of claim 5, wherein the first connector portion is attached to the attachment portion by an arm.

7. The modular interconnecting element of claim 6, wherein
the first connector portion extends from a tip, through an approximately 180-degree bend, to a shank that is approximately straight for an initial length, and then gently curves to an intersection with the arm;
a nub is formed at an opposite side of the intersection at approximately a 90-degree angle with the arm and is configured to secure a fit with the second connector portion; and
the tip, the bend, the shank, and the nub together define a receptacle that is configured to receive and form a fit with the second connector portion of the second modular interconnecting element.

8. The modular interconnecting element of claim 7, comprising at least two connector portions, wherein the at least two connector portions are not aligned in the same plane.

9. The modular interconnecting element of claim 1, wherein the attachment portion is formed by interconnecting the first connector portion with the second connector portion of the second modular interconnecting element.

10. The structure comprising the modular interconnecting element of claim 7 interconnected with the second modular interconnecting element.

11. The structure of claim 10, wherein
the first connector portion is interconnected with the second connector portion;
the tip of the first connector portion is received within a receptacle of the second connector portion and forms a fit with the second connector portion; and
the bend of the first connector portion is partially overlaid by a nub of the second connector portion to secure the fit between the first and second connector portions.

12. The structure of claim 10, wherein
each modular interconnecting element comprises three connector portions connected to a central attachment portion by three arms;
six modular interconnecting elements are interconnected to form a hexagonal unit having a central void and six bosses for attachment to the surface; and
a plurality of the hexagonal units are interconnected such that the structure has a form of a modular shelving unit.

13. The structure of claim 10, wherein
each modular interconnecting element comprises four connector portions connected to a central attachment portion by two Y-shaped arms; and
a plurality of the modular interconnecting elements are interconnected such that the structure has a form of a modular shelving unit.

14. The structure of claim 10, wherein
the first modular interconnecting element comprises five universal connector portions connected to a central attachment portion by five arms;
the second modular interconnecting element comprises six universal connector portions connected to a central attachment portion by six arms; and
a plurality of the first modular interconnecting elements and a plurality of the second modular interconnecting elements are interconnected such that the structure has a form of a sphere.

15. The structure of claim 14, further comprising a skin fastened to the sphere by fasteners that are fastened through the skin and the attachment portions of the modular interconnecting elements to form an enclosed sphere.

16. A modular interconnecting element comprising:
a first connector/attachment portion configured to interconnect with a second connector/attachment portion of a second modular interconnecting element,
wherein the interconnection of the first and second connector/attachment portions forms a boss for attachment of a structure formed by the first and the second modular interconnecting elements to a surface.

17. The modular interconnecting element of claim 16, wherein the modular interconnecting element comprises three connector/attachment portions formed at ends of three arms, and wherein opposite ends of the three arms interconnect at a central portion of the modular interconnecting element.

18. The modular interconnecting element of claim 17, wherein each connector/attachment portion includes a U-shaped portion connected to an end of an arm, a bowl-shaped portion formed opposite to and facing the U-shaped portion, a cup-shaped portion joining the U-shaped portion and the bowl-shaped portion, and a reinforcement member co-linear with the arm and extending away from the top of the bowl-shaped portion.

19. The modular interconnecting element of claim 18, wherein the U-shaped portion, the bowl-shaped portion, and the cup-shaped portion together form a receptacle for receiving and forming a suitable fit with another connector/attachment portion.

20. A method for forming a modular interconnecting element, comprising:
forming the modular interconnecting element with a connector portion configured to interlock with a connector portion of an adjacent modular interconnecting element; and
forming the modular interconnecting element with an attachment portion configured to attach a structure formed by multiple modular interlocking elements to a surface.
